(19) United States
(12) Patent Application Publication
(10) Pub. No.: US 2026/0029517 A1
(43) Pub. Date: Jan. 29, 2026

(54) SENSOR CONTAMINATION IDENTIFICATION

(71) Applicant: GM Global Technology Operations LLC, Detroit, MI (US)

(72) Inventors: Sai Vishnu Aluru, Commerce Twp., MI (US); Chao-Hung Lin, Canton, MI (US); Alexander Lesnick, Alexandria, VA (US); Patrick A. Whitten, Royal Oak, MI (US)

(21) Appl. No.: 18/782,837

(22) Filed: Jul. 24, 2024

(51) Int. Cl. G01S 7/497; B60S 1/56; G01S 17/86; G01S 17/894; G06V 10/98; G06V 20/58

(52) U.S. Cl. CPC G01S 7/497; B60S 1/56; G01S 17/86; G01S 17/894; G06V 10/993; G06V 20/58; G01S 2007/4977

(57) ABSTRACT

A vehicle includes a sensor including a receiver, the sensor being configured to generate an output. A controller is communicatively coupled with the sensor. The controller includes a memory and a processor. The memory stores instructions for determining an object obstruction rate of the output and detecting a contamination rate of the receiver based at least in part on obstruction rate of the output.

### INTRODUCTION

The subject disclosure relates to vehicles, and in particular to vehicles including a contamination detection and response for optical sensors included in a vehicle perception system.

Modern vehicles utilize sensors to detect parameters of a surrounding environment. The parameters are combined in a controller using a perception system to generate a view of the environment. This view is then used in conjunction with other control systems such as automated driver systems, driver assistance systems, driver warning systems, object detection systems environment displays, as well as other possible systems where information about the surrounding environment is pertinent. The combined systems of sensors and control modules used to generate this view is collectively referred to as a perception system.

Some types of sensors used for the perception systems include optical sensors that receive light and form a sensor output based on the received light. If the receiver becomes contaminated, due to debris, inclement weather, dirt, or any other contamination, the fidelity of the received light is reduced and the quality of the sensor output is decreased. This can, in turn, negatively affect the quality of the view of the environment provided by the perception system.

Accordingly, it is desirable to provide a system for identifying and rectifying sensor contamination in one or more perception system sensors.

### SUMMARY

In one exemplary embodiment a vehicle includes a sensor including a receiver, the sensor being configured to generate an output. A controller is communicatively coupled with the sensor. The controller includes a memory and a processor. The memory stores instructions for determining an object obstruction rate of the output and detecting a contamination rate of the receiver based at least in part on obstruction rate of the output.

In addition to one or more of the features described herein the sensor is an optical sensor.

In addition to one or more of the features described herein the sensor is one of a camera and a light dimension and ranging (LiDAR) sensor.

In addition to one or more of the features described herein the memory further stores a look up table correlating the object obstruction rate with a corresponding contamination rate and with a corresponding remedial action.

In addition to one or more of the features described herein the corresponding remedial action includes at least one of ignore contamination, engage clearing implement, notify a driver of contamination, and remove the sensor from a set of perception system sensors until the sensor is manually cleared.

In addition to one or more of the features described herein the look up table is constructed by correlating contamination rates detected in a controlled environment with object recognition rates detected in an uncontrolled environment.

In addition to one or more of the features described herein the contamination rates detected in the controlled environment are determined using a set of determinators, with each determinator corresponding to a parameter impacted by contamination.

In addition to one or more of the features described herein the sensor is a camera and the determinators include a contrast and edge profile determinator, a luma value determinator and a noise value determinator.

In addition to one or more of the features described herein the sensor is a LiDAR sensor and the determinators include a noise determinator, a point cloud density determinator, and a reflection magnitude determinator.

In addition to one or more of the features described the contamination rate is a statistical aggregation of contamination rates determined by the set of determinators.

In addition to one or more of the features described herein the statistical aggregation of contamination rates includes a weighted averaging of the contamination rates determined by the set of determinators.

In another exemplary embodiment a method for identifying contamination of a sensor includes isolating a frame of a sensor output, determining an object recognition rate of the sensor output and consulting a look up table to identify a contamination rate corresponding to the object recognition rate of the sensor output, and identifying and implementing at least one remedial action corresponding to the contamination rate, wherein the at least one remedial action is stored in the look up table.

In addition to one or more of the features described herein the at least one remedial action is at least one of engaging a sensor cleaning implement, notifying a driver to clean the sensor and removing the sensor from a set of perception system sensors.

In addition to one or more of the features described herein the look up table is generated by operating the sensor in a controlled environment with a known contamination and determining a controlled contamination rate, operating the vehicle in an uncontrolled environment with a known contamination rate and determining an uncontrolled object recognition rate, and correlating the uncontrolled object recognition rate with the controlled contamination rate.

In addition to one or more of the features described herein the uncontrolled object recognition rate is an obscured percentage of at least one detected object in a sensor output.

In addition to one or more of the features described herein the at least one detected object is detected in the frame by using object recognition on a combination of the frame and a contemporaneous output from at least one other sensor.

In addition to one or more of the features described herein the controlled contamination rate is a statistical aggregation of outputs of a plurality of determinator, where each determinator in the plurality of determinators corresponds to a frame parameter correlated with contamination.

In addition to one or more of the features described herein the sensor is a camera and the plurality of determinators includes a contrast and edge profile determinator, a luma value determinator, and a noise value determinator.

In addition to one or more of the features described herein the sensor is a light detection and ranging (LiDAR) sensor and the plurality of determinators includes a noise value determinator, a point cloud density determinator, and a reflection magnitude determinator.

The above features and advantages, and other features and advantages of the disclosure are readily apparent from the following detailed description when taken in connection with the accompanying drawings.

In another exemplary embodiment a vehicle includes a sensor including a receiver. The sensor is configured to generate a sensor output. A controller is communicatively coupled with the sensor, wherein the controller includes a memory and a processor, the memory storing instructions for determining an object obstruction rate of the output and detecting a contamination rate of the receiver based at least in part on obstruction rate of the output using a method including isolating a frame of the sensor output, determining an object recognition rate of the sensor output and consulting a look up table to identify a contamination rate corresponding to the object recognition rate of the sensor output, and identifying and implementing at least one remedial action corresponding to the contamination rate, wherein the at least one remedial action is stored in the look up table.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle including a perception system;

FIG. 2 is a process for identifying one or more contaminated sensor receivers in the perception system of FIG. 1; and

FIG. 3 is a process for creating a look up table for use in the examples of FIGS. 1 and 2.

### DETAILED DESCRIPTION

The following description is merely exemplary in nature and is not intended to limit the present disclosure, its application or uses. In particular, while described in detail with regards to optical sensors herein, the system and methods may be adapted with minimal alterations to apply to any sensor type that may be susceptible to receiver obstruction.

It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

In accordance with an exemplary embodiment a vehicle perception system monitors sensor outputs to determine an object recognition rate of objects detected by the sensor. The percentage of a detected object that is obscured within a single frame of the sensor output is referred to as the object recognition rate of that object. The perception system quantifies contamination and its impact on the models of the external environment using a look-up table. The look up table correlates the contamination in a controlled environment (e.g. laboratory testing) and object recognition rates in an uncontrolled environment (e.g., road driving) allowing a controller to identify a contamination response based on an object recognition rate. In some examples, the continued generation of data from operation in the uncontrolled environment can be utilized to further train a neural network for assisting in prediction of contamination and cleaning scheduling.

Once a contamination rate has been determined, the vehicle perception system compares the contamination rate to a look up table and, based on the entries within the look up table, determines if the contamination rate should be remedied, and if so, in what form the remedy should be implemented. Exemplary forms of remedy can include engaging a cleaning mechanism, instructing a driver to clean the receiver, activating a redundant backup system, changing the weighting of the sensing information from the contaminated sensor for perception and decision systems, sending alert signals to a remote operator, and changing a setting of the sensor.

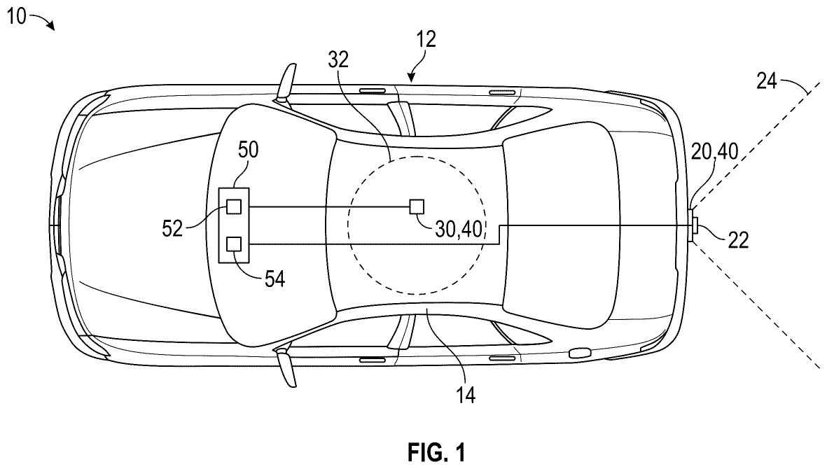

With continued reference to the general perception system process described above, FIG. 1 illustrates a vehicle 10 including a body 12 and a passenger compartment 14. Disposed about the body 12 are sensors, including a camera 20 and a light distance and ranging (LiDAR) sensor 30. The camera 20 and the LiDAR sensor 30 are generically referred to as optical sensors 40 and include receivers configured to receive light from the surrounding environment. In a practical example, the vehicle 10 may include multiple additional sensors including additional optical sensors 40, as well as other types of ranging (e.g. RADAR) sensors.

Each of the optical sensors 40 is in communication with a perception system controller 50. The perception system controller 50 is illustrated in the example of FIG. 1 as a stand alone controller, including a memory 52 and a processor 54. In alternative examples, the perception system controller 50 may be a subcomponent of a general controller, a set of processes distributed throughout a network of controllers, or any similar controller configuration able to communicate with the optical sensors 40 and the remainder of the perception system components.

Referring to the camera 20 specifically, the camera 20 is disposed at a rear of the vehicle body 12 and provides a rear facing field of view 24. In some embodiments a wiper, or other clearing implement 22 is disposed on, or next to, the camera 30 and provides a mechanical mechanism for clearing contaminants such as dirt, debris, rain water, snow, etc. from a camera lens (the receiver portion of the camera 20) or a camera cover without requiring a driver or operator to stop the vehicle 10. The clearing implement 22 can be independently controlled via a communication with the perception system controller 50, or controlled as a subcomponent of the camera 20 depending on the particular implementation.

Referring now to the LiDAR sensor 30, the LiDAR sensor 30 is disposed at a center point of the vehicle body 12, such as on a roof of the vehicle 10, and emits light in predetermined directions. The emitted light is reflected back to a receiver portion of the LiDAR sensor 30. The time period from emission to receipt of the reflection is measured and a distance that the light traveled is determined. Based on the time of flight and the angles, a point cloud 32 is generated. The point cloud 32 is a set of coordinate points where the light was reflected from as determined by the time of flight and angle of the received reflection. While illustrated as a circle contained within the vehicle body 12 for ease of illustration, it is appreciated that a practical point cloud 32 will extend substantially beyond the edges of the vehicle body 12 and will include data points identifying multiple extrinsic features such as trees, other vehicles, pedestrians, curbs, and the like. The perception system controller 50 consolidates information from all of the available sensors, including the optical sensors 40, into a view of the surrounding environment.

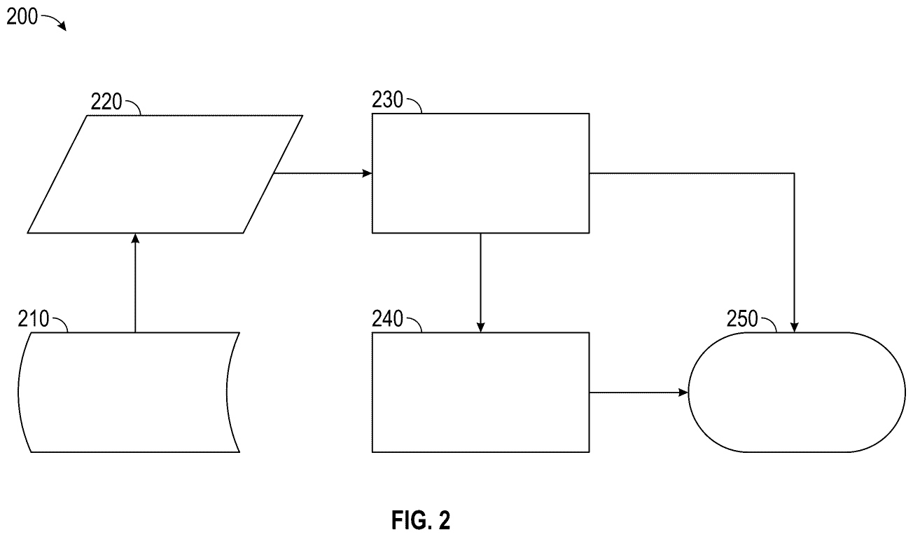

With continued reference to FIG. 1, FIG. 2 illustrates a process 200 for determining how obstructed an optical sensor 40 is and for determining a rectifying response. For sensors that include a clearing mechanism 22, such as the camera 20, the rectifying response can include an automatic clearing of the receiver. For other optical sensors 40, the rectifying response can include actions such as removing the optical sensor 40 from the set of available sensors, notifying a driver that the optical sensor 40 should be cleaned, or any similar action.

The process 200 initially receives a sensor output 210 and captures a frame 220 from the sensor output 210. The frame 220 is an instantaneous reading of the sensor output 210. In the case of a camera based sensor (e.g. camera 20), the frame 220 is a still image of the field of view. In the case of a LiDAR sensor 30, the frame is an instantaneous capture of the point cloud 32.

The perception system controller 50 then verifies an amount of contamination in a verify contamination step 230. The amount of contamination is referred to as a contamination rate and refers to a percentage of the frame 220 obscured due to contamination. The contamination rate during vehicle operation is determined by using perception system object recognition processes, such as machine learning and/or neural network based object recognition, and determining what percentage of each detected object is obscured in the frame 220. The total percentage obscured (up to a maximum of 100%) is utilized as a proxy for the contamination rate of the receiver.

After verifying the rate of contamination, the contamination rate is compared to a look up table stored in the memory 50, with the look up table correlating the contamination rate with the suggested rectifying action. By way of example, the look up table may indicate that a contamination rate under 50% requires no action, a contamination rate from 51%-75% requires notification to the driver and/or engaging a cleaning implement 22, and a contamination rate exceeding 75% requires the perception system controller 50 to stop relying on the optical sensor 40 (remove the optical sensor 40 from the set of usable sensor data) until the sensor is cleared.

In cases where the determined rectifying action is an automated clearing action (e.g. activation of the clearing implement 22), the action is triggered in a trigger cleaning step 240, and the frame is passed to the remainder of the perception system to be utilized, displayed, or implemented in a pass to perception step 250 depending on the needs of perception system.

As contamination typically builds incrementally over time, the process 200 can be performed periodically (e.g. every minute, every engine cycle, etc.) and does not need to be performed for every frame of every optical sensor 40. In a practical example, the perception system controller 50 stores a default frequency at which the process 200 is performed for each optical sensor 40. Furthermore, the particular conditions in which the vehicle 10 is operating may be determined by one or more other vehicle systems and impact the frequency of performing the process 200. By way of example, if a vehicle system determines that the vehicle 10 is operating on a dirt road, the process 200 may be performed at an increased rate. In contrast, if the vehicle system determines that the vehicle 10 is operating on a highway at relatively high speeds, the process 200 may be performed at a decreased rate.

In some cases one or more control systems in communication with the perception system controller 50 may instruct the perception system controller 50 to check for contamination outside of the identified frequency. When such an instruction is received, the perception system controller 50 checks for contamination using the same process.

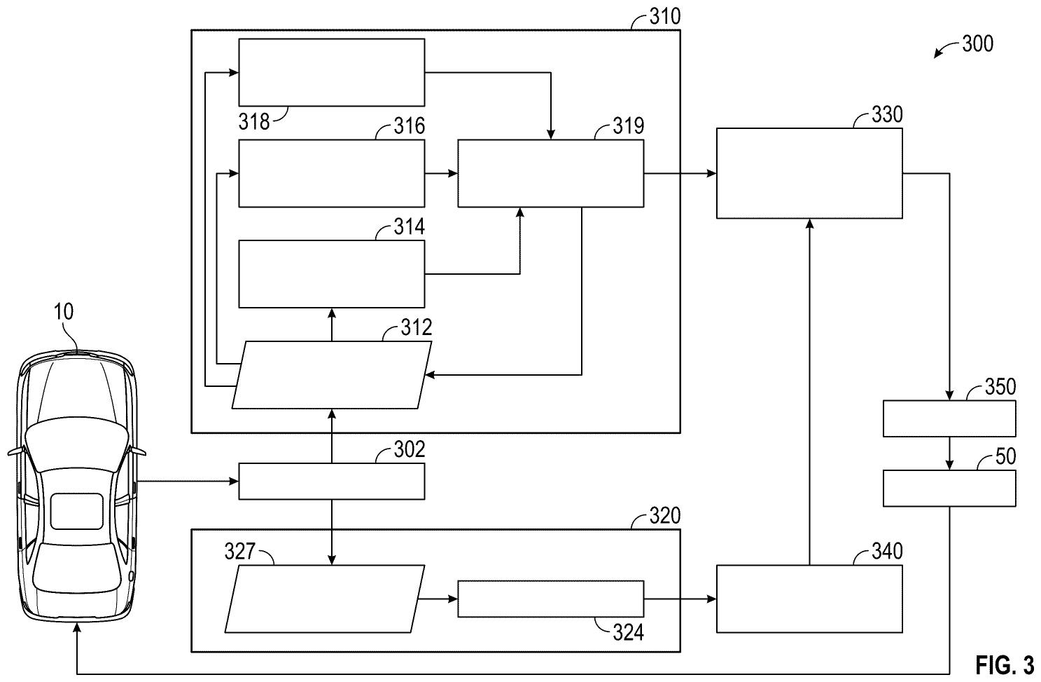

With continued reference to FIGS. 1 and 2, FIG. 3 illustrates a process 300 for developing and implementing the look up table utilized in the process 200 of FIG. 2. The particular values in a given look up table are specific to a vehicle design, and are determined during design and testing according to the process 300.

The process 300 includes a controlled environment portion 310 and an uncontrolled environment portion 320. The controlled environment portion 310 is performed in a laboratory, or in another location where the conditions of the test are known, and where the contamination rate of the optical sensor 40 is known ahead of the test.

The controlled portion 310 receives a sensor output 302 from the optical sensor 40 and acquires a frame of the sensor data in an acquire frame step 312. The controlled portion 310 then determines a set of parameters corresponding to a contamination rate via determinators 314, 316, 318. In an example where the optical sensor 40 is a camera, the determinators 314, 316, 318 can analyze the frame to determine contrast and edge profiles (determinator 314), determine luma values (determinator 316), and determine noise values in the image (determinator 318).

In alternate examples, different determinator's indicative of contamination may be utilized and/or the weighting of the determinators 314, 316, 318 may be adjusted depending on how controlling the corresponding parameter is for determining contamination. By way of example, a LiDAR sensor 30 may utilize noise, point cloud density and reflection magnitude determinators 314, 316, 318. In further examples, more or less determinations 314, 316, 318 may be utilized and the set of three determinators is exemplary in nature. Each determinator 314, 316, 318 identifies a contamination rate corresponding to the determined values and outputs the determined contamination rate.

Each of the determinators 314, 316, 318 is run simultaneously, and provides output to a contamination rate aggregator 319. The contamination rate aggregator 319 combines the identified determined parameters into a single contamination rate using a statistical analysis. The determined contamination rate is provided from the contamination rate aggregator 319 to a correlation system 330 where the contamination rate is stored for combination with the results of operation of the uncontrolled environment portion 320.

In the uncontrolled environment 320, the vehicle 10 begins operation with a known contamination on the optical sensor 40, and is operated in a real world uncontrolled environment (e.g. a road). During operation, frames are acquired in an acquire frame step 327 and provided to perception systems in the perception system controller 50 in a perception stack step 324. The perception stack step 324 utilizes existing perception techniques to identify objects in the image and determine what percentage of each object is obscured or distorted. In some instances, the object detection may be performed solely on the acquired frame. In other instances, the object detection may be based on a combination of the acquired frame and data from multiple additional sensors within the perception system.

After identifying the objects in the frame using the perception stack 324, the process determines an object recognition rate corresponding to what percentage of the object is discernible in the frame in a determine object recognition rate step 340. In some embodiments, relative positioning of the detected object may be considered and weighted accordingly. By way of example, if an object is immediately proximate an edge of the frame (in a camera 20 output) it can be inferred that a portion of the object may be out of frame and not obscured by contamination, and thus that object should have a reduced weight when determining the contamination rate. The determined object recognition rates are provided to the correlation system 330.

Once testing has been performed in both the controlled portion 310 and the uncontrolled portion 320, the correlation system 330 uses a statistical analysis to correlate the contamination rates from the contamination rate aggregator 319 with the object recognition rates from the object recognition step 340. Based on the correlation, a look up table (LUT) is create in a create look up table step 350. The look up table lists entries for ranges of object recognition rates, and correlates each range to a corresponding contamination rate and suggested remedy. The look up table provides a calculation free conversion from a determined object recognition rate to rectifying action for the contamination. In some examples, multiple look up tables may be created with each look up table corresponding to one or more extrinsically knowable conditions. By way of example, different look up tables may be created for different weather conditions (rain, snow, etc.) and/or for different terrain (paved, dirt, off-road, etc.).

Lastly the look up table is provided to the perception system controller 50, and stored in the memory 52 for utilization in the process 200 of FIG. 2.

In some examples, the uncontrolled environment portion 320 may be continuously updated and run during standard vehicle operation, providing a training set for neural network and AI analysis of the object recognition rate. In these examples, the object recognition step 340 is periodically retrained with the newly stored data.

Similarly, the stored data from continued operation in an uncontrolled environment 320 may be used to train a predictive neural network. In such an example, the predictive neural network may, once a sufficient data set has been established, replace the look up table with a more tailored and granular system for identifying contamination and suggesting or implementing remedies.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
a sensor including a receiver, the sensor being configured to generate an output; and
a controller communicatively coupled with the sensor, wherein the controller includes a memory and a processor, the memory storing instructions for determining an object obstruction rate of the output and detecting a contamination rate of the receiver based at least in part on the object obstruction rate of the output.

2. The vehicle of claim 1, wherein the sensor is an optical sensor.

3. The vehicle of claim 2, wherein the sensor is one of a camera and a light dimension and ranging (LiDAR) sensor.

4. The vehicle of claim 1, wherein the memory further stores a look up table correlating the object obstruction rate with a corresponding contamination rate and with a corresponding remedial action.

5. The vehicle of claim 4, wherein the corresponding remedial action includes at least one of ignore contamination, engage clearing implement, notify a driver of contamination, and remove the sensor from a set of perception system sensors until the sensor is manually cleared.

6. The vehicle of claim 4, wherein the look up table is constructed by correlating contamination rates detected in a controlled environment with object recognition rates detected in an uncontrolled environment.

7. The vehicle of claim 6, wherein the contamination rates detected in the controlled environment are determined using a set of determinators, with each determinator corresponding to a parameter impacted by contamination.

8. The vehicle of claim 7, wherein the sensor is a camera and the determinators include a contrast and edge profile determinator, a luma value determinator and a noise value determinator.

9. The vehicle of claim 7, wherein the sensor is a LiDAR sensor and the determinators include a noise determinator, a point cloud density determinator, and a reflection magnitude determinator.

10. The vehicle of claim 7, wherein the contamination rate is a statistical aggregation of contamination rates determined by the set of determinators.

11. The vehicle of claim 10, wherein the statistical aggregation of contamination rates includes a weighted averaging of the contamination rates determined by the set of determinators.

12. A method for identifying contamination of a sensor of a vehicle comprising:
isolating a frame of a sensor output;
determining an object recognition rate of the sensor output and consulting a look up table to identify a contamination rate corresponding to the object recognition rate of the sensor output; and
identifying and implementing at least one remedial action corresponding to the contamination rate, wherein the at least one remedial action is stored in the look up table.

13. The method of claim 12, wherein the at least one remedial action is at least one of engaging a sensor cleaning implement, notifying a driver of a vehicle to clean the sensor and removing the sensor from a set of perception system sensors.

14. The method of claim 12, wherein the look up table is generated by operating the sensor in a controlled environment with a known contamination and determining a controlled contamination rate, operating a vehicle in an uncontrolled environment with a known contamination rate and determining an uncontrolled object recognition rate, and correlating the uncontrolled object recognition rate with the controlled contamination rate.

15. The method of claim 14, wherein the uncontrolled object recognition rate is an obscured percentage of at least one detected object in a sensor output.

16. The method of claim 15, wherein the at least one detected object is detected in the frame by using object recognition on a combination of the frame and a cotemporaneous output from at least one other sensor.

17. The method of claim 14, wherein the controlled contamination rate is a statistical aggregation of outputs of a plurality of determinators, where each determinator in the plurality of determinators corresponds to a frame parameter correlated with contamination.

18. The method of claim 17, wherein the sensor is a camera and the plurality of determinators includes a contrast and edge profile determinator, a luma value determinator, and a noise value determinator.

19. The method of claim 17, wherein the sensor is a light detection and ranging (LiDAR) sensor and the plurality of determinators includes a noise value determinator, a point cloud density determinator, and a reflection magnitude determinator.

20. A vehicle comprising:
a sensor including a receiver, the sensor being configured to generate a sensor output;
a controller communicatively coupled with the sensor, wherein the controller includes a memory and a processor, the memory storing instructions for determining an object obstruction rate of the sensor output and detecting a contamination rate of the receiver based at least in part on obstruction rate of the sensor output using a method including isolating a frame of the sensor output, determining an object recognition rate of the sensor output and consulting a look up table to identify a contamination rate corresponding to the object recognition rate of the sensor output, and identifying and implementing at least one remedial action corresponding to the contamination rate, wherein the at least one remedial action is stored in the look up table.
